(19) United States
(12) Patent Application Publication
(10) Pub. No.: US 2011/0175038 A1
(43) Pub. Date: Jul. 21, 2011

(54) COATED CARBON NANOFLAKES

(75) Inventors: Kun Hou, Milpitas, CA (US); Dennis M. Manos, Williamsburg, VA (US); Ronald A. Outlaw, Williamsburg, VA (US)

(73) Assignee: College of William & Mary

(21) Appl. No.: 12/359,435

(22) Filed: Jan. 26, 2009

Related U.S. Application Data
(60) Provisional application No. 61/024,071, filed on Jan. 28, 2008.
(60) Provisional application No. 61/193,971, filed on Jan. 14, 2009.

(51) Int. Cl. H01B 1/04; H01B 1/02; B05D 5/12; B05D 3/10; B82Y 30/00; B82Y 40/00

(52) U.S. Cl. 252/504; 252/506; 252/502; 252/509; 427/77; 977/775; 977/890

(57) ABSTRACT

Compositions of carbon nanoflakes are coated with a low Z compound, where an effective electron emission of the carbon nanoflakes coated with the low Z compound is improved compared to an effective electron emission of the same carbon nanoflakes that are not coated with the low Z compound or of the low Z compound that is not coated onto the carbon nanoflakes. Compositions of chromium oxide and molybdenum carbide-coated carbon nanoflakes are also described, as well as applications of these compositions. Carbon nanoflakes are formed and a low Z compound coating, such as a chromium oxide or molybdenum carbide coating, is formed on the surfaces of carbon nanoflakes. The coated carbon nanoflakes have excellent field emission properties.

### CROSS-REFERENCE TO RELATED APPLICATIONS

This Application claims priority to U.S. Provisional application Ser. No. 61/024,071, filed on Jan. 28, 2008, and US Provisional application titled “Coated Carbon Nanoflakes” (attorney docket no. 047911/0108), filed on Jan. 14, 2009, both of which are incorporated herein by reference in their entirety.

### STATEMENT REGARDING FEDERALLY SPONSORED RESEARCH AND DEVELOPMENT

This invention was made with Government support under Grant No. N00014-05-1-0749 awarded by the Office of Naval Research. The Government has certain rights in the invention.

### FIELD OF INVENTION

The field of the invention relates to compositions of coated carbon nanoflakes and applications thereof, particularly for vacuum microelectronics.

### BACKGROUND OF THE INVENTION

High current with sufficient current density, long lifetime, good emission stability and spatial uniformity are general requirements of cold cathode materials for application in vacuum microelectronic devices. Carbon nanosheets, carbon nanotubes or nanofibers, and metallic single tips are three important candidates for use as the electron source in field emission devices such as field emission displays (FEDs), microwave power amplifier tubes, and compact x-ray sources. In U.S. patent application Ser. No. 10/574,507 (hereby incorporated by reference), Wang et al. describe carbon nanosheet compositions and methods for making these compositions. These carbon nanosheets have shown promising field emission performances, making them a competitive cold cathode material among carbon nanotubes and Spindt-type field emission arrays. Currently, the spatial emission uniformity of carbon nanosheets, as well as that of carbon nanotubes and Spindt-type arrays, are not satisfactory for practical device operations but can be improved by proper conditioning. The conditioning processes, usually time-consuming, lead to degraded field emission performances of carbon nanosheets. Therefore, it is important to improve the spatial emission uniformity of carbon nanosheets while keeping their field emission performances intact or enhanced.

Efforts have been made to improve the intrinsic field emission properties of these candidates by incorporating low work function material coatings such as ZrC or HfC.

The present inventors have studied the field emission properties of carbon nanosheets coated with ZrC and NbC (1 nm and 10 nm thick coating each), but did not observe enhanced field emission performance compared to uncoated carbon nanosheets. This failure is probably caused by the trade-off between the lower work function of ZrC nanobeads and a decreased local field enhancement factor due to the geometry of these nanobeads.

Accordingly, there is a need in the art for coated carbon nanoflakes with improved field emission properties.

### BRIEF SUMMARY OF THE INVENTION

One embodiment of the invention provides compositions of carbon nanoflakes coated with a low Z compound, where an effective electron emission of the carbon nanoflakes coated with the low Z compound is improved compared to an effective electron emission of the same carbon nanoflakes that are not coated with the low Z compound or of the low Z compound that is not coated onto the carbon nanoflakes.

Another embodiment of the invention provides compositions of thin-film-coated carbon nanoflakes, where the thin film portion of the thin-film-coated carbon nanoflakes comprises chromium oxide having an atomic composition percentage of chromium between 0.33 and 0.40 or comprises molybdenum carbide. For example, compositions of chromium oxide-coated nanoflakes (CrOₓ—CNF), compositions of molybdenum carbide-coated nanoflakes (MoₓC—CNF), and applications thereof are described.

Another embodiment of the invention provides a field emitter comprising CrOₓ—CNF or MoₓC—CNF.

Another embodiment of the invention provides a method of making coated carbon nanoflakes, including forming a metal coating on the carbon nanoflakes and converting the metal coating to a coating comprising at least one of a metal oxide, nitride, carbide, boride, or a combination thereof, such that an effective electron emission of the coated carbon nanoflakes is improved compared to an effective electron emission of the carbon nanoflakes that are uncoated or of the coating that is not coated onto the carbon nanoflakes.

### BRIEF DESCRIPTION OF THE DRAWINGS

The summary above, and the following detailed description, will be better understood in view of the drawings which depict details of preferred embodiments.

FIG. 1 shows a schematic diagram of exemplary equipment for depositing chromium oxide-coated carbon nanoflake compositions of the present invention.

FIGS. 2a-b show Energy Dispersive X-ray (EDX) analysis accompanied with SEM images of (a) as-grown carbon nanoflakes, and (b) CrOₓ—CNF.

FIG. 3 shows an Auger spectrum of CrOₓ—CNS.

FIGS. 4a-e show plan-view SEM images of (a) as-grown CNS and (b-e) CrOₓ—CNS having progressively increasing coating thicknesses of approximately: (b) 0.5 nm chromium oxide coating on either side of the carbon nanosheet, (c) 1.5 nm chromium oxide coating on either side of the carbon nanosheet, (d) 15 nm chromium oxide coating on either side of the carbon nanosheet, and (d) 20 nm chromium oxide coating on either side of the carbon nanosheet,

FIGS. 5a-c show (a) SEM, (b) PEEM, and (c) FEEM images of a upatterned CrOx-CNS sample.

FIG. 6 shows field emission curves of as-grown CNS and CrOₓ—CNS, plotting emission current as a function of the applied electric field.

FIGS. 7a-d show FEEM images of CrOₓ—CNS, with a field of view 300 μm in diameter, taken at (a) 4.34 V/μm, (b) 4.08 V/μm, (c) 3.58 V/μm, and (d) 3.33 V/μm.

FIG. 8 shows a field emission curve of CrOₓ—CNS having a chromium oxide coating thickness of about 1.5 nm on either face of the carbon nanoflakes.

FIG. 9 shows the current density of CrOₓ—CNS samples as a function of the applied electric field. Results are graphed from CrOₓ—CNS samples having coating thicknesses of 1.5 nm and 15 nm (on each face).

FIG. 10 shows the emission current of CrOₓ—CNS samples having varying chromium oxide coating thicknesses as a function of the applied electric field.

FIG. 11 shows a schematic of the diode cartridge assembly loaded with a CNS dot sample of 3 mm diameter on a doped silicon substrate.

FIGS. 12a and 12b show scanning electron micrographs of carbon nanosheets grown on a W grid cylindrical element, showing the cross section and plan views of the growth. The sheets are freestanding and roughly vertical in orientation. FIG. 12b also shows that the edges are on the order of 1 nm (four graphene sheets) or less. FIG. 12c is a schematic cross section of the sheets showing that the base is planar graphite for about 20 nm thick and then turns vertical at the grain boundaries. The inset of FIG. 12c shows the hydrogen termination of the graphene edges.

FIG. 13a is an AES spectrum from 170 to 300 eV of the as-grown (without coating) CNS. FIG. 13b is an AES spectrum from 170 to 300 eV of the CNS coated with 3 monolayers (“ML”) of Mo. FIG. 13c is an AES spectrum from 170 to 300 eV of Mo-coated CNS after heating to 1000° C. Note the triple peak structure of Mo₂C superimposed on the graphite peak at 270 eV.

FIG. 14 is an AES spectrum from 50 to 600 eV of the stoichiometric Mo₂C calibration sample showing the characteristic triple peak of the carbide at 250 to 275 eV. The major peaks i⁺ and i⁻ give an asymmetry ratio AR=0.7.

FIG. 15 shows the variation in concentration of the AES peaks as a function of temperature in 100° C. increments up to 1000° C. The formation of the Mo₂C begins at 100° C., reaches a plateau at 200° C., and begins a gradual increase that continues up to 1000° C. In concert with this behavior, there is a precipitous drop in the free Mo signal to 200° C. and a gradual decline that continues up to 1000° C.

FIGS. 16a and 16b are scanning electron micrographs showing the beading of the Mo₂C at 1000° C. The underlying hexagonal structure is quite stable and does not react with the Mo deposition. The beads are about 10 nm in diameter. FIGS. 16c and 16d are scanning electron micrographs of another sample heated to only 275° C. No beading is observed and the Mo₂C coating is quite conformal. The procedure is used to produce the coated sample for field emission testing.

FIG. 17a shows a sum spectrum of a weighted spectrum of Mo₂C shown in FIG. 13 (a weighting factor of 17% applied) digitally superimposed on a weighted spectrum of uncoated CNS (a weighting factor of 17% applied), matching the actual spectrum of coated CNS shown in FIG. 17b. FIG. 17b is an AES spectrum of coated CNS measured after heating a second sample of Mo/CNS to 275° C. for 30 minutes. The Mo not combined with the adventitious C slowly diffuses into the CNS bulk. The digital match required only 2 mL Mo indicating that the significant fraction of the Mo did not combine.

FIG. 18 shows I-V characteristics of the Mo₂C-coated CNS sample heated to only 275° C. compared to as-grown CNS. Note the significant improvement in both threshold and the current for a given applied field.

FIG. 19a shows Fowler-Nordheim plots for maximum excursions of current to 300 μA for the Mo₂C-coated CNS sample and the standard deviations from the average least mean squares fit for six as-grown CNS samples. The Mo₂C-coated CNS correlation coefficients are very good (R2=0.999). FIG. 19b shows Fowler-Nordheim plots of raw data from a typical as-grown CNS sample demonstrating slight nonlinearity and a representative Mo₂C-coated CNS sample at a maximum current of 200 μA shown with standard deviations over 100 ramps.

### DETAILED DESCRIPTION OF THE INVENTION

The present invention is directed to novel compositions of coated carbon nanoflakes and methods for their use.

In one embodiment, carbon nanoflakes are coated with a low Z compound, where Z is the proton number of one or more of the elements forming the compound. An effective electron emission of the carbon nanoflakes coated with the low Z compound is improved compared to an effective electron emission of the same carbon nanoflakes that are not coated with the low Z compound or of the low Z compound that is not coated onto the carbon nanoflakes.

The low Z compound can be selected from a metal oxide, nitride, carbide, boride, or any combination thereof to form a binary, ternary, quaternary, etc. compound. The combinations include oxynitride, oxycarbide, boronitride, oxynitrocarbide, etc. compounds.

In the low Z compound, the metal may be selected from one of more transition metals, such as Ti, Mo, Zr, Y, Sc, etc., rare earth group metals, such as La, Hf, Ce, Th, etc., alkali group metals, such as Li, Na, etc., or alkaline earth group metals, such as Mg or Ba. Non-limiting examples of the low Z compound include lanthanum boride, scandium boride, yttrium boride, molybdenum carbide, titanium oxide, chromium oxide, hafnium oxide, thorium oxide, molybdenum oxide, zirconium oxide, cerium oxide, etc. However, other compounds which improve the effective electron emission properties of the carbon nanoflakes may be used. It should be noted that the low Z compounds may be either electrically conducting, such as molybdenum carbide, or electrically insulating, such as chromium oxide. Without wishing to be bound by a particular theory, the inventors believe that for electrically insulating compound coatings that have a small thickness, such as a thickness of less than 15 nm, for example less than 5 nm, electron tunneling across the band gap provides an improved effective electron emission.

As will be described in more detail below, the low Z compound coating preferably has a thickness of 0.5 to 5 nm. However, other thicknesses may be used if they improve the emission properties. The thickness of the “knife edge” carbon nanoflake portion of said coated carbon nanoflakes that is upstanding from the substrate (i.e., which is substantially perpendicular to the substrate surface, including deviations of up to 10 degrees from normal to the substrate surface) is preferably less than 3 nm, such as 1-2 nm. In this case, the carbon nanoflakes preferably comprise carbon nanosheets.

As used herein, the term “effective electron emission” includes any suitable electron emission parameters. In one embodiment, this term includes one or more of work function, turn on voltage and field enhancement factor. Thus, the carbon nanoflakes coated with the low Z compound have at least one or more of a lower work function, a lower turn on voltage and a higher field enhancement factor compared to that of the same carbon nanoflakes that are not coated with the low Z compound or of the low Z compound that is not coated onto the carbon nanoflakes. Without wishing to be bound by a particular theory, the inventors believe that the improved effective electron emission may be due to an enhancement of the dipole moment on the knife edge surface of the coated nanoflakes, which allows the electrons to escape the coated nanoflakes easier than uncoated nanoflakes.

A method of making coated carbon nanoflakes includes forming a metal coating on the carbon nanoflakes and converting the metal coating to a coating comprising at least one of a metal oxide, nitride, carbide, boride, or a combination thereof, such that an effective electron emission of the coated carbon nanoflakes is improved compared to an effective electron emission of the carbon nanoflakes that are uncoated or of a coating that is not coated onto the carbon nanoflakes. In one embodiment, the step of converting comprises exposing the metal coating to an atmosphere comprising oxygen, nitrogen, carbon, boron or a combination thereof. For example, to form a chromium oxide coating, a chromium metal coating is formed on the nanoflakes followed by exposing the chromium to an oxygen-containing ambient, such as pure oxygen or air, to convert the chromium to chromium oxide. To form a carbide, the metal may be reacted with the carbon nanoflakes during or after deposition (i.e., due to the elevated temperature of the metal deposition and/or a post deposition anneal) and/or exposed to a hydrocarbon containing ambient. Alternatively, to form a carbide, the metal may be reacted with the carbon flakes during or after the deposition under vacuum. The metal may be deposited by any suitable deposition method, such as evaporation, sputtering, chemical vapor deposition (including metal organic chemical vapor deposition), atomic layer deposition, etc.

The coated carbon nanoflakes may be used in any suitable device or application, such as a field emission device (“field emitter”). The field emitters may be used in display devices (such as plasma display devices), microwave tubes, thrusters or engines in space applications, and medical uses, such as accelerators for disinfection and sterilization of medical instruments and components.

The term “Carbon Nanoflakes” (“CNF”) refers to a range of carbon nanostructures. Generally, these CNF are sheet-like forms of graphite. CNF have a thickness of 10 nanometers or less. In some embodiments, the thickness is 5 nanometers or less, such as 2 nanometers or less, and preferably 1 nanometer or less. CNF with thicknesses of 2 nanometers or less may be referred to as “carbon nanosheets” or “CNS”. The thickness of CNS can vary from a single graphene layer to two, three, four, or more layers.

CNF have a height ranging from 100 nanometers to up to 8 μm. In some embodiments, CNF will have a height of 100 nm to 500 nm, such as 100 nm to 2 μm, or in some embodiments between 2.5 μm and 8 μm, such as 2.5 μm to 5 μm. Carbon nanosheets that have not been coated may be referred herein to as carbon nanosheets, as “uncoated carbon nanosheets”, or “as-grown carbon nanosheets”.

The following embodiments will describe exemplary chromium oxide and molybdenum carbide-coated CNF. However, it should be understood that other low Z coatings may also be used.

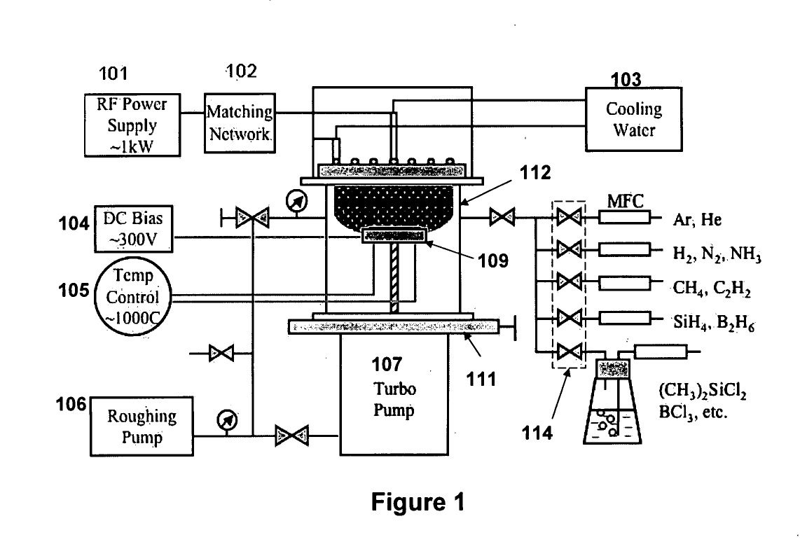

A radio frequency plasma enhanced chemical vapor deposition (RFCVD) apparatus may be used to synthesize carbon nanosheets described herein. The plasma in an RFCVD apparatus may be generated by applying RF power to a planar coil and coupling the power through a dielectric window. Depending on the mechanism of power coupling, RFCVD is able to operate under either a capacitively coupled mode or an inductively coupled mode. The plasma density of inductively coupled plasma is usually on the order of 10¹¹ cm⁻³, 10 times higher than that of capacitively coupled plasma. A schematic diagram of the RFCVD apparatus used to synthesize carbon nanoflakes described herein is shown in FIG. 1. The apparatus was built upon a grounded stainless steel chamber (111) equipped with a mechanical pump (106) and a turbo molecular pump (107), creating a base pressure of ˜10⁻⁶ Torr. A quartz window (112) polished on both faces, with a thickness of 1.27 cm, lies on top of the chamber. This window works as a dielectric medium for the power transfer from the RF coil antenna (not shown) to the plasma. A matching box (102) containing two variable vacuum capacitors is connected between the RF power supply (101) and the antenna in order to tune the operation mode of the plasma. A water cooling system (103) may be provided. A temperature control system (105) is used to control the temperature of the sample stage (109) in which a commercial ceramic heater is incorporated, and the distance from the sample stage (109) to the quartz window can be adjusted from 3 cm to 10 cm. The heater allows the substrate temperature to be heated to temperatures of approximately 1200° C., higher than the temperature required for carbon nanoflake deposition. Gases such as Ar, He, N₂, NH₃, H₂, CH₄, and C₂H₂ can be introduced into the chamber by separate mass flow controllers (114). If desired, a DC bias system (104) may be provided.

Carbon nanoflakes can be successfully deposited on a variety of substrates including Si, Al₂O₃, SiO₂, Ni, Ti, W, TiW, Mo, Cu, Au, Pt, Zr, Hf, Nb, Ta, Cr, stainless steel, and graphite. CH₄ is used a feedstock gas, but alternative feedstock gases such as acetylene may also be used. The as-grown (also referred to as as-received) CNF samples can be coated using a number of methods known in the art to produce CrOₓ—CNF. For example, CNF can be placed in a vacuum evaporator, and a chromium layer can be evaporated onto the surface of the CNF. Other methods that could be used include but are not limited to sputtering, chemical vapor deposition, and atomic layer deposition. The duration of the evaporation process can be manipulated to adjust the thickness of the chromium oxide coating.

Field emission is a process by which electrons are extracted from a solid material into the vacuum by an intense electric field (10⁷-10⁸ V/cm). It is a quantum-mechanical phenomenon in which electrons tunnel through a potential barrier at the surface of a solid as a result of the electric field. The external electric field lowers the surface barrier that confines the electrons within the solid so that the barrier becomes nearly triangular in shape. As the width of the surface potential barrier at the Fermi energy approaches 2 nm, electrons will have a significant probability to tunnel from the highest occupied states of the solid into the vacuum.

Field emission measurement is conducted by applying an electric field between the sample and an anode and measuring the current collected in the anode. Field emission testing requires a high vacuum environment, usually with the pressure of the testing chamber on the order of 1×10⁻⁸ Torr or better, to minimize gas effects on the sample performance. A field emission test system typically includes five major components: an ultra-high vacuum (UHV) testing chamber, a sample holder assembly, a high voltage power supply unit, a current measurement unit, and a PC-based data collection system. The sample holder assembly is the core component of the field emission test system, which usually consists of an anode, a cathode (the specimen under test), a sample stage, spacers, and other parts.

Photoelectron emission microscopy (PEEM) is a non-destructive surface microscopic imaging technique that uses photons for illumination. Without the photon source, PEEM can be deployed as a field emission electron microscope (FEEM) to investigate the field emission property of the specimen. PEEM uses both photoelectrons and field emission electrons ejected from the specimen surface for imaging. When photons with kinetic energy larger than the work function of the specimen strike the surface of the specimen, photoelectrons can be emitted from the specimen surface with a kinetic energy, usually on the order of several eVs, defined by:

Eₖ=hv−Φ

where Φ is the work function of the specimen. To the extent that Φ varies with topography and surface composition, these low energy photoelectrons provide local topographical information about the specimen surface and compositional surface sensitivity of PEEM observations. An accelerating electric field on the order of several V/μm is applied between the specimen mounted in the cathode lens and the first objective lens (the extractor) to collect low energy photoelectrons for imaging. Therefore, field emission electrons escaping from the surface are captured by the microscope to form surface images. These field emission electrons give information about emission sites in the form of a single spot or clusters of bright spots. Even though PEEM images both photoelectrons and field emission electrons simultaneously using the same electron optics, photoelectrons can be made to dominate the image by lowering the extraction field to values near (or below) the field emission threshold field of the specimen.

FEEM images can be captured by simply increasing the accelerating voltage with the illumination source switched off. Information about the distribution of emission sites and emission uniformity of the specimen can be acquired from these FEEM images.

In one embodiment, chromium oxide-coated CNF are described. Depending on the final application of CrOₓ—CNF, one may prefer different thicknesses and heights of CNF as starting materials. Carbon nanoflakes that have thicknesses of 2 nanometers or less; i.e., carbon nanosheets, are often preferred for applications exploiting the magnetic or field emission properties of CrOₓ—CNF. In such cases, the chromium oxide-coated products can be referred to as chromium oxide-coated carbon nanosheets (CrOₓ—CNS). Accordingly, CrOₓ—CNS constitutes one class of CrOₓ—CNF.

CrOₓ—CNF can be synthesized by coating chromium oxide onto carbon nanoflakes or by coating chromium onto carbon nanoflakes followed by converting chromium to chromium oxide. In one embodiment of the invention, the CrOₓ—CNF have coatings of chromium oxide with thicknesses between about 0.5 nm and about 20 nm. In some embodiments of the invention particularly useful in field emission applications, the carbon nanoflakes, prior to coating, have thicknesses between about 1 nm and about 3 nm, and the chromium oxide coatings are applied such that the thickness of the coating is between about 0.5 nm and about 15 nm, more preferably between about 1 and about 5 nm. In some embodiments, the atomic percentage of chromium in the chromium oxide coating is between 0.33 and 0.40. In one embodiment, the CrOx-CNF have a lower turn-on field, and better field emission performance, than CNF that have not been coated. In some embodiments preferred for field emission applications, the CrOx-CNF have at least a 25% lower turn-on field than CNF not been coated.

In another embodiment, molybdenum carbide-coated CNF are described. While Mo₂C composition of molybdenum carbide is preferred, other compositions may be used as well. Hence molybdenum carbide will be referred to as MoₓC herein, where 1.5≦x≦52.5. Depending on the final application of MoₓC—CNF, one may prefer different thicknesses and heights of CNF as starting materials. Carbon nanoflakes that have thicknesses of 2 nanometers or less; i.e., carbon nanosheets, are often preferred for applications exploiting the magnetic or field emission properties of MoₓC—CNF. In such cases, the molybdenum carbide-coated products can be referred to as molybdenum carbide-coated carbon nanosheets (MoₓC—CNS). Accordingly, MoₓC—CNS constitutes one class of MoₓC—CNF.

MoₓC—CNF can be synthesized by coating molybdenum carbide onto carbon nanoflakes or by coating molybdenum onto carbon nanoflakes followed by converting molybdenum to molybdenum carbide. In some embodiments, the step of converting the metal coating is conducted by annealing the Mo-coated CNF under a temperature from 100° C. to 800° C., preferably 150° C. to 600° C., preferably 200° C. to 400° C. to react Mo with CNF. In one embodiment of the invention, the MoₓC—CNF has initial coatings of molybdenum (before it is converted to molybdenum carbide) with thicknesses between about 0.5 nm and about 20 nm. In some embodiments of the invention particularly useful in field emission applications, the carbon nanoflakes, prior to coating, have thicknesses between about 1 nm and about 3 nm, and the molybdenum carbide coatings have a thickness of between about 0.5 nm and about 15 nm, more preferably between about 1 and about 5 nm. In one embodiment, the MoₓC—CNF has a lower turn-on field, and better field emission performance, than CNF that have not been coated. In some embodiments preferred for field emission applications, the MoₓC—CNF have a significantly lower turn-on field than CNF not been coated, for example a turn-on field as low as or lower than around 6 V/μm.

### EXAMPLES

The examples that follow are intended in no way to limit the scope of this invention but are provided to illustrate representative embodiments of the present invention. Many other embodiments of this invention will be apparent to one skilled in the art.

### Example 1

### Synthesis of CrOₓ—CNS

A four-inch, heavily-doped Si wafer (resistivity of 0.003-0.005 Ω·cm) was loaded on the sample stage (109 as shown in FIG. 1), and the RF-PECVD apparatus was pumped down to 1 mTorr. Hydrogen gas was first introduced into the system at 6 sccm while the substrate was heated up to approximately 700° C., at which temperature it was held for approximately 30 minutes to ensure uniform heating. Then, CH₄ was added to the chamber at 4 sccm and the apparatus pressure was stabilized at approximately 100 mTorr. An RF plasma was ignited and tuned as the power was increased to 900 W over the course of about one minute. Deposition was conducted for 20 minutes. The apparatus was cooled down for at least 30 minutes in a hydrogen atmosphere before the sample was taken out.

The as-grown CNS samples were placed in a vacuum evaporator, and a chromium layer was subsequently evaporated on the surface of the CNS. A tungsten wire twisted into a conical shape was applied as the resistance heater in the evaporator. A high-purity chromium chip was used as the evaporation source in this work. The evaporator was first pumped down to ˜10⁻⁶ Torr, and a direct current of approximately 20 amperes was applied to the tungsten wire. The evaporation was conducted for several seconds, and the CrOₓ—CNS was then exposed to the atmosphere. A color change from black to grey was visually observed after chromium evaporation and subsequent exposure to the atmosphere. Evaporation times of 2 seconds, 5 seconds, 10 seconds, and 15 seconds produced chromium oxide coating thicknesses of 0.5 nm, 1.5 nm, 15 nm, and 20 nm, respectively, as shown in Table 1.

TABLE 1

Evaporation time (s)

| | 2 | 5 | 10 | 15 |
|---|---|---|---|---|
| Coated CNS thickness (nm) | 3 | 5 | 32 | 42 |
| CrOₓ thickness (nm) | ~0.5 | ~1.5 | ~15 | ~20 |

### Example 2

### Characterization of CrOₓ—CNS

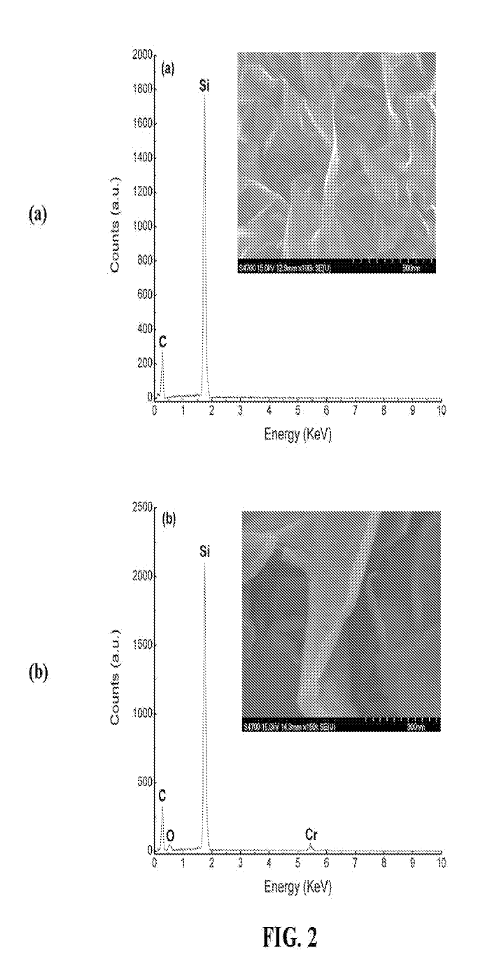

Elemental analyses of as-grown CNS and CrOₓ—CNS were conducted by Energy Dispersive X-ray (EDX) analysis accompanied with SEM images. Carbon nanosheets were coated with chromium oxide using 15 seconds evaporation time according to the method of Example 1. FIG. 2a shows the elemental distribution profile extracted from the EDX survey across the sample area of as-grown CNS seen in the SEM image (inset). Peaks associated with C and Si are observed in the profile. The Si peak originates from the substrate on which nanosheets grow and the C peak comes from the CNS. No other elements are detected within this sample area. In contrast to as-grown CNS, the EDX spectrum of CrOₓ—CNS shown in FIG. 2b not only has peaks associated with C and Si, but also has peaks corresponding to Cr and O, confirming the formation of chromium oxide coating on CNF.

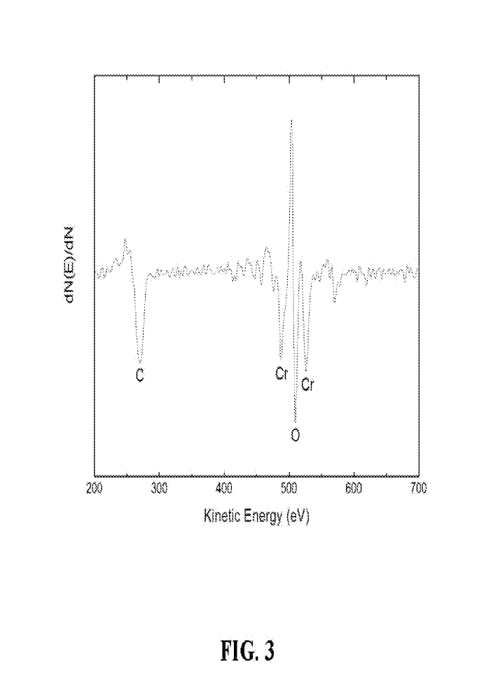

FIG. 3 shows an Auger spectrum of CrOₓ—CNS fabricated using 10 seconds chromium evaporation time according to the methods of Example 1. Instead of a single C peak as would be observed from as-grown CNS, Cr and O peaks are clearly visible in the Auger spectrum, confirming the formation of a chromium oxide thin layer on the surface of the CNS. The atomic composition percentage of chromium in the chromium oxide coating was determined from the amplitudes of Cr and O peaks in the spectrum and their relative sensitive factors, which are 0.33 for Cr and 0.5 for O with the electron beam at an incident energy of 3 kV. Therefore, the atomic composition percentage is estimated to be 0.37, very close to the theoretical ratio for Cr₂O₃. The small deviation from the theoretical value of 0.4 may be an indication of the presence of chromium oxide having other stoichiometries, such as CrO₂.

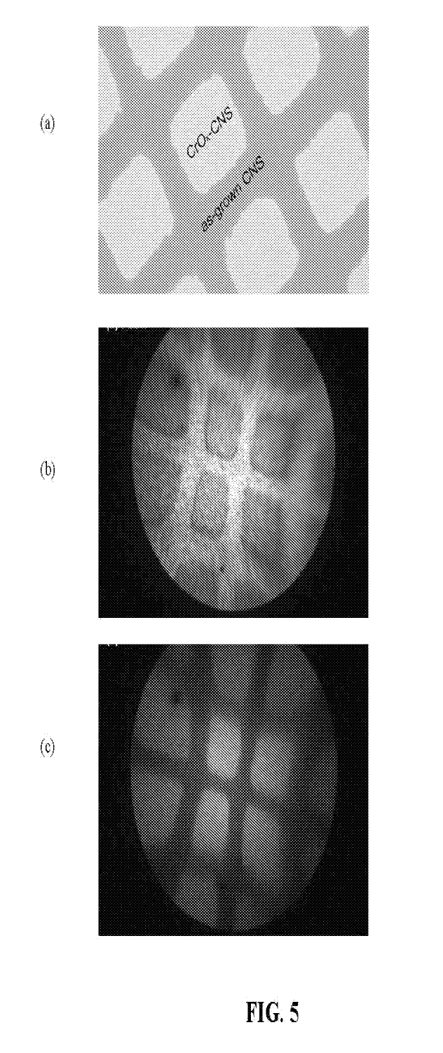

Raman spectra (not shown) of as-grown CNS and CrOₓ—CNS were collected from a CrOₓ—CNS sample that has a patterned structure obtained by using a TEM grid as the mask on top of the CNS sample during the vacuum evaporation coating process. Square pads of CrOₓ—CNS and “streets” of as-grown CNS were alternatively formed on the same sample, as shown in FIG. 5a. Raman spectra were obtained from a square pad of CrOₓ—CNS and its nearest as-grown CNS street by focusing the incident laser beam inside these regions of the sample to reduce the spatial-induced spectrum deviation. Three peaks were found in the Raman spectrum of as-grown CNS, including a disorder-induced D peak at 1355 cm⁻¹, a tangential-mode G peak at 1583 cm⁻¹, and a D′ shoulder at 1620 cm⁻¹. The intensity ratio of the D peak to the G peak (I_{D}/I_{G}) in the spectrum of as-grown CNS is ˜0.50, consistent with the value of typical CNS. These same three peaks were obtained in the Raman spectrum of CrOₓ—CNS, and an additional peak was observed from CrOₓ—CNS that is located at 551 cm⁻¹. Published Raman data indicates that Cr₂O₃ has a strong peak at 551 cm⁻¹ and two weak peaks at 397 and 609 cm⁻¹. Accordingly, the 551 cm⁻¹ peak can be assigned to Cr₂O₃. A broad band in the Raman spectrum of CrOₓ—CNS between 551 cm⁻¹ and 800 cm⁻¹ suggests the existence of other stoichiometries of chromium oxide.

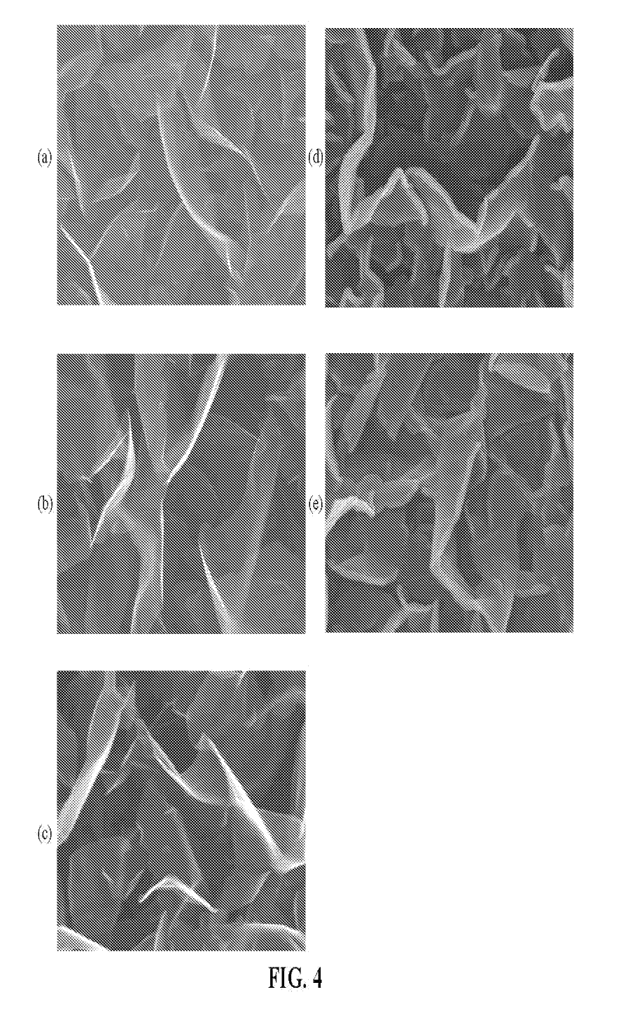

SEM images of CrOₓ—CNS and as-grown CNS are shown in FIG. 4. Here, the CrOₓ—CNS were fabricated with different thicknesses of chromium oxide coating obtained by conducting the vacuum evaporation coating step for varying lengths of time, as described in Example 1 and Table 1. The top-view image of as-grown CNS, i.e., uncoated CNS, shown in FIG. 4a, reveals typical nanosheet structure, with corrugated assemblies of folded graphitic sheets having smooth surfaces that are on the order of 1000 nm long and approximately 2 nm thick. Top view images of CrOₓ—CNS having Cr evaporation times of 2, 5, 10, and 15 seconds are displayed in FIG. 4b, FIG. 4c, FIG. 4d, and FIG. 4e, respectively. These coating times produced CrOₓ—CNS samples having the coating thicknesses shown in Table 1, determined as an average value throughout the sample. Since CrOₓ layers are fabricated on both sides of the CNS, the thickness of the coating can be approximated by halving the thickness difference of the nanoflakes before and after the evaporation.

### Example 3

### Field Emission Properties of CrOₓ—CNS with 15 nm Chromium Oxide Coating

To directly compare the field emission performance of CrOₓ—CNS and as-grown CNS, patterned CrOₓ—CNS samples were used for PEEM and FEEM observations. PEEM captures both photoelectrons generated by the photon source and field emission electrons extracted by the applied electric field to form images while FEEM only uses field emission electrons for imaging with the absence of photon source in PEEM. The contrast information of PEEM and FEEM images yields the spatial distributions of electron source in the sample and thereby determines the emission uniformity of the sample. Patterned CrOₓ—CNS samples were fabricated by using an evaporation time of 10 seconds through a TEM grid that was placed over as-grown CNS samples, resulting in a sample consisting of alternating CrOₓ—CNS squares and as-grown CNS streets. PEEM systems operating at pressures on the order of ˜10⁻⁸ Torr were used to conduct these observations with four CrOₓ—CNS samples.

The CrOₓ—CNS squares were approximately 50 μm×50 μm in area, and separated from each other by as-grown CNS streets 25 μm in width. An electric field of ˜4 V/μm was applied between the patterned CrOₓ—CNS sample (cathode) and the extractor of PEEM (anode) during PEEM and FEEM observations. FIGS. 5a, 5b, and 5c show SEM, PEEM, and FEEM images, respectively, of the patterned CrOₓ—CNS samples described above. FIG. 5a provides an SEM image that reveals that a well-patterned structure was formed on the CNS sample. FIG. 5b is a PEEM image that clearly depicts the dark CrOₓ—CNS squares and the bright as-grown CNS streets. Emission current measurements of the patterned sample, taken in the field of view with a diameter of 300 μm that contains alternating squares and streets, indicated that the collected currents were 2.4 pA for photoelectron emission and 0.1 pA for field electron emission. Photoelectrons were therefore the dominant electron source for imaging. The PEEM image suggests that CrOₓ—CNS squares generated fewer photoelectrons than as-grown CNS streets, which is consistent with the fact that the wide-bandgap CrOₓ coating can suppress the photoelectron production from the wavelength of light used in this instrument. The FEEM image shown in FIG. 5c, however, presents bright CrOₓ—CNS squares and dark as-grown CNS streets, suggesting an enhanced field emission property of CrOₓ—CNS. The turn-on field of CrOₓ—CNS was less than 4 V/μm since the patterned structure was already visible in the FEEM image. Moreover, the almost equal brightness of CrOₓ—CNS squares over the entire field of view is indicative of their excellent emission uniformity. The slight brightness variation among CrOₓ—CNS squares is caused by the electron optics of the microscope.

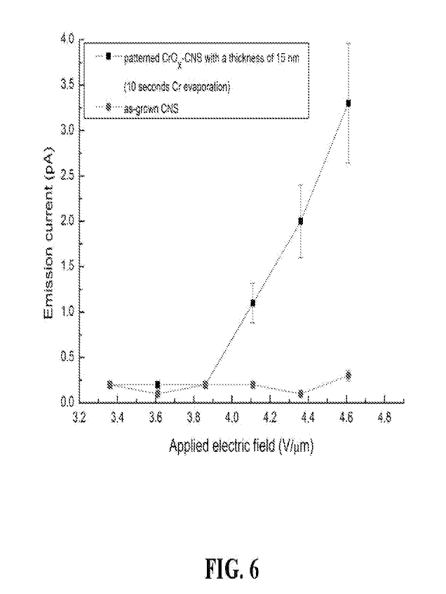

Emission currents (I) of CrOₓ—CNS and as-grown CNS as a function of the applied electric field (V) were measured during the FEEM observations. As noted, the patterned CrOₓ—CNS and as-grown CNS came from the same sample. FIG. 6 shows the collected emission current of patterned CrOₓ—CNS and as-grown CNS at varying applied electric fields. No electron emission from as-grown CNS was detected in FEEM observations, while the collected emission currents from as-grown CNS were less than 0.3 pA at all applied electric fields. Accordingly, we can conclude that as-grown CNS did not turn on at the low applied electric fields of this instrument. In contrast, the CrOₓ—CNS squares started emitting electrons at an applied electron field of 3.86 V/μm. Even though the collected emission current from the patterned CrOₓ—CNS was only 0.2 pA at this field, the CrOₓ—CNS squares were clearly visible in FEEM images. A turn-on field (defined as the minimum electric field that must be applied to the sample in order to produce 10 nA emission current) of 3.86 V/μm is consistent with previous described observations of CrOₓ—CNS.

Thereafter, the collected emission current increased to 3.3 pA at an applied electric field of 4.61 V/μm.

### Example 4

### Field Emission Properties of CrOₓ—CNS with 1.5 nm Chromium Oxide Coating

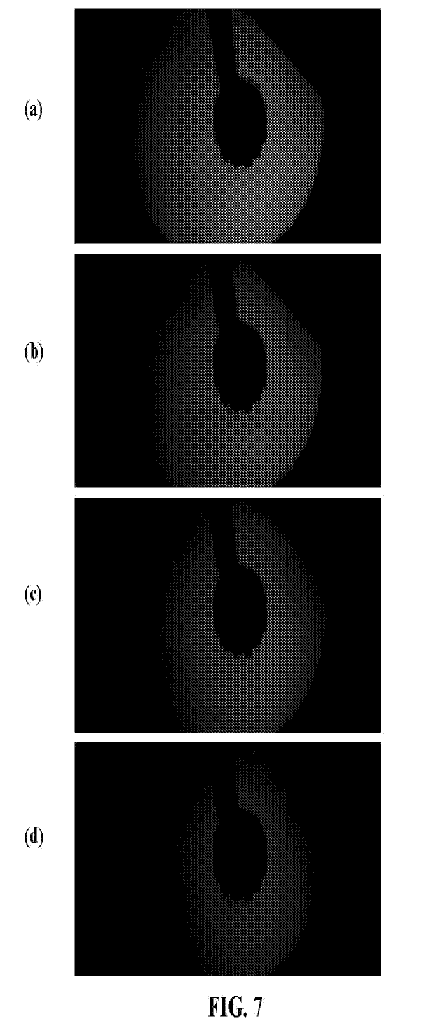

PEEM and FEEM observations were conducted on CrOₓ—CNS samples synthesized according to the methods of Example 1. The CNS samples were subjected to a coating step of five seconds duration, yielding a chromium oxide coating thickness of approximately 1.5 nm on each side. FIGS. 7a-7d are FEEM images, taken at various applied electric fields with a field of view of 300 μm in diameter, of CrOₓ—CNS having 1.5 nm chromium oxide coatings. FIG. 7a shows a FEEM image taken at an applied electric field of 4.34 V/μm, FIG. 7b shows a FEEM image taken at an applied electric field of 4.08 V/μm, FIG. 7c shows a FEEM image taken at an applied electric field of 3.58 V/μm, and FIG. 7d shows a FEEM image taken at an applied electric field of 3.33 V/μm. All of these FEEM images indicate that the electron emission from CrOₓ—CNS is spatially uniform over the field of view, with only a slight brightness variation caused by the electron optics. FEEM observations over the whole surface of the sample at various applied electric fields yielded no hot runners, further confirming the spatially uniform emission of CrOₓ—CNS.

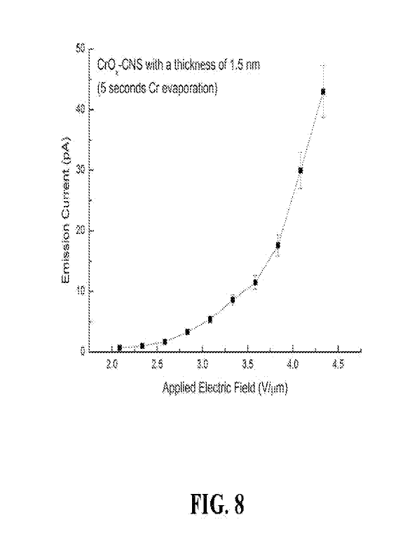

FEEM images of the CrOₓ—CNS were first observed at an applied electric field of 2.33 V/μm, although the imaging system was not able to record them until the field increased to 3.33 V/μm. Accordingly, we conclude that the turn-on field of these CrOₓ—CNS was approximately 2.33 V/μm. FIG. 8 displays the collected emission current of the CrOₓ—CNS as a function of the applied electric field. The collected current increased from 1 pA to 43 pA as the applied electric field was increased from 2.33 to 4.33 V/μm, consistent with the increasing brightness of FEEM images demonstrated in FIGS. 7a-7d as the applied field was increased. The error bars in FIG. 8 represent the collected current fluctuation recorded at each measured field.

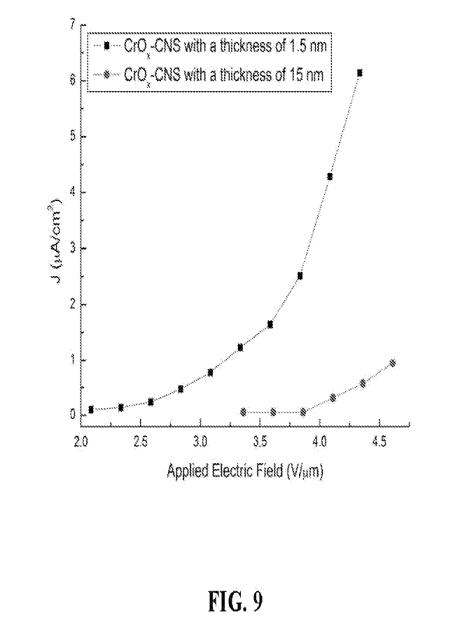

The electron emission profiles from CrOₓ—CNS samples having a coating thickness of either 1.5 nm or 15 nm were both uniform, and a direct comparison of their spatially averaged field emission is valid provided one accounts for the actual area incorporated in the field of views. FIG. 9 displays the current density (J) of CrOₓ—CNS samples having coating thicknesses of 1.5 nm and 15 nm as a function of the applied electric field. The low collected current density measured here results from the electron loss during the transport in the electron optic system of PEEM. As is apparent in FIG. 9, the CrOₓ—CNS samples with 1.5 nm chromium oxide coatings had a superior field emission performance relative to the CrOₓ—CNS samples having 15 nm chromium oxide coatings, as demonstrated by the lower turn-on field and higher emission current at every value of the applied electric field. Therefore, the field emission performance of CrOₓ—CNS is dependent on the coating thickness.

### Example 5

### Effects of Coating Thickness on Field Emission of CrOₓ—CNS

The field emission properties of CrOₓ—CNS samples having a variety of coating thicknesses were studied using a diode holder assembly in an UHV test system. CrOₓ—CNS samples were used as the cathode and separated from a 6 mm wide copper anode by alumina spacers having a thickness of 254 μm. The chamber pressure was adjusted to approximately 4×10⁻⁸ Torr at the beginning of each test and the test area of samples was 30 mm². The coating thicknesses of CrOₓ—CNS samples used in this study were controlled by vacuum evaporation time. Evaporation times of 2 seconds, 5 seconds, 10 seconds, and 15 second produced chromium oxide coating thicknesses of 0.5 nm, 1.5 nm, 15 nm, and 20 nm, respectively, as per Table 1. The as-grown CNS samples used to produce CrOₓ—CNS were cleaved from a central area of an as-grown CNS wafer four inches in diameter in order to minimize the height and morphology variation of CNS across the different coated samples.

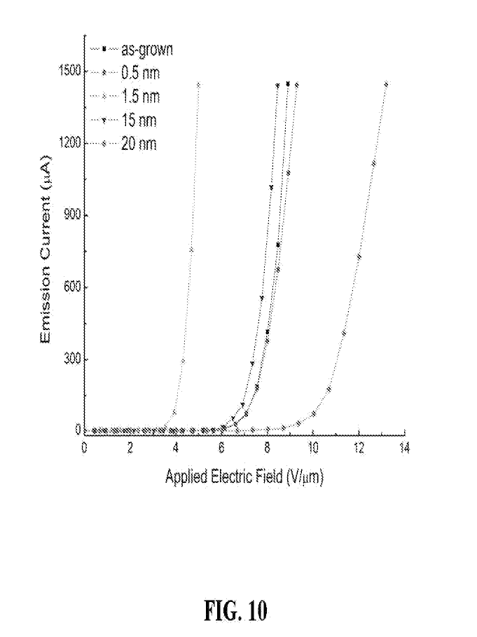

FIG. 10 shows the emission current of CrOₓ—CNS samples of varying chromium oxide coating thicknesses as a function of the applied electric field (I-V curves). Here, each I-V curve is the average of ten measurements from CrOₓ—CNS samples having the same coating thickness. The field emission data of these I-V curves are summarized in Table 2, which shows the turn-on field and the field required to generate a peak current of 1.45 mA for CrOₓ—CNS samples having a variety of coating thicknesses.

TABLE 2

| Chromium Oxide | | | | | |
|---|---|---|---|---|---|
| Coating Thickness on | 0 nm | | | | |
| CNS | (uncoated) | 0.5 nm | 1.5 nm | 15 nm | 20 nm |
| Turn-on field | 4.25 | 4.3 | 2.4 | 3.9 | 6.1 |
| (V/μm) | | | | | |
| Field required to | 8.9 | 9.3 | 5.0 | 8.5 | 13.2 |
| generate a peak current | | | | | |
| of 1.45 mA (V/μm) | | | | | |

The I-V curve of as-grown CNS shows a turn-on field of 4.25 V/μm, and the applied electric field required for as-grown CNS to generate a peak current of 1.45 mA was 8.9 V/μm. The I-V curves of CrOₓ—CNS with coating thicknesses of 1.5 nm and 15 nm indicate that their turn-on fields were 2.4 V/μm and 3.9 V/μm, respectively (only a small deviation from the values measured in Example 4). The applied electric fields required to generate a peak current of 1.45 mA were 5.0 V/μm for the 1.5 nm-coated CrOₓ—CNS and 8.5 V/μm for the 15 nm-coated CrOₓ—CNS. Thus, chromium oxide-coated nanosheets with a coating thickness of 15 nm showed better field emission performance than as-grown CNS. Moreover, CrOₓ—CNS with a coating thickness of 1.5 nm showed a better field emission performance than CrOₓ—CNS with a coating thickness of 15 nm, consistent with the previously described results shown in FIG. 9.

CrOₓ—CNS with a coating thickness of 0.5 nm had a turn-on field of 4.3 V/μm, while CrOₓ—CNS with a coating thickness of 20 nm had a turn-on field of 6.1 V/μm. The applied electric fields required to generate a peak current of 1.45 mA were 9.3 V/μm for the 0.5 nm-coated CrOₓ—CNS and 13.2 V/μm for the 20 nm-coated CrOₓ—CNS. Thus, chromium oxide coating thicknesses that deviate from a desirable range of thickness can negatively impact field emission performance.

### Example 6

### Synthesis of MoₓC—CNS

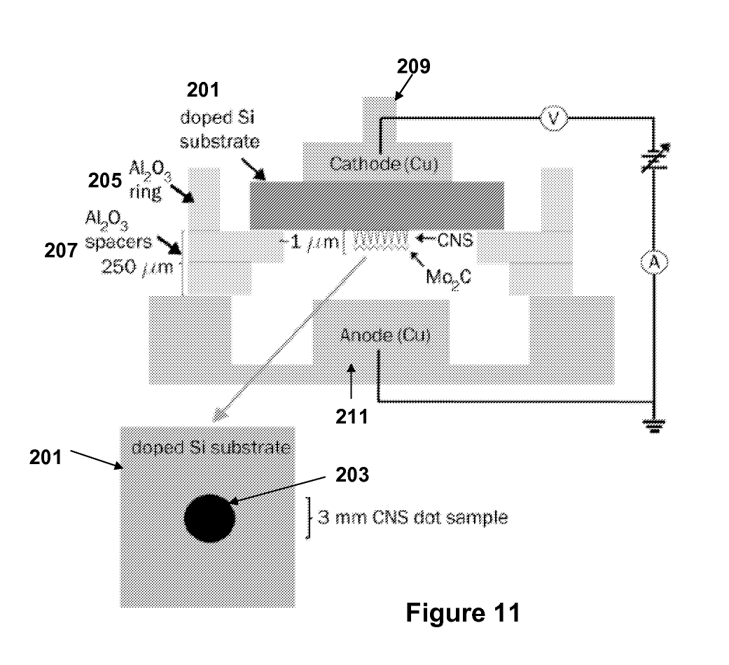

The nanosheets (CNS) were grown by a method substantially the same as the method described in Example 1. Briefly, the CNS were grown in a RF PECVD system at 13.56 MHz and 900 W power coupled into a stainless steel vacuum chamber by a three-turn, coiled planar antenna through a quartz window on top of the chamber. An inductively coupled plasma was formed by adjusting chamber pressure (p˜90-100 mTorr, 40% CH₄, 60% H₂), the RF magnitude, and phases of the RF voltage and coil current in the coiled, planar antenna configuration. The substrate temperature was kept at 680° C.; the growth time was 20 min. The nanosheets, roughly vertical in orientation, approximately 600 nm high, 500 nm wide, and 1 nm thick, were obtained. The overall CNS sample size, as illustrated in FIG. 11, was a 3 mm diameter dot (203), deposited on a cleaved 6×6 mm² coupon of n-type (100) Si substrate (201) (p=0.001-0.005 μl cm). Detailed description of CNS synthesis has been reported in J. J. Wang et al., Appl. Phys. Lett. 85, 1265 (2004) and J. J. Wang, et al., Carbon 42, 2867 (2004), which are hereby incorporated by reference in their entirety.

Physical vapor deposition (PVD) of the Mo was done in the introduction chamber with a rod-fed MDC E-vap 100 and a 99.998% pure polycrystalline Mo target. The melt ball was formed by electron impact at 2 kV and 8 mA and was located of 12.5 cm from the substrate surface along the surface normal.

### Example 7

### Characterization of MoₓC—CNS

Surface analysis was performed within a multifunctional ultrahigh vacuum (UHV) system, base pressure of ˜1×10⁻¹¹ Torr, equipped with a Physical Electronics 15-255 GAR cylindrical mirror analyzer that is used for Auger electron spectroscopy (AES) and x-ray photoelectron spectroscopy focused on the same sample spot. The system is also capable of ion bombardment for cleaning and depth profiling. The sample stage was wired for resistance heating of the sample up to 1200° C. in front of any of the system diagnostics, thus permitting real-time analysis up to that temperature. Samples as large as 2×2 cm² can be installed in an introduction chamber, with a base pressure of ˜1×10⁻⁹ Torr, and degassed by radiant heating (up to 500° C.) or by glow discharge. After degassing, the sample can then be transferred into the analysis chamber for spectroscopy. Separately, scanning electron micrographs (SEMS) were taken with a Hitachi S-4700 equipped with energy dispersive x-ray analysis. The ultimate resolution of the instrument is ˜1 nm.

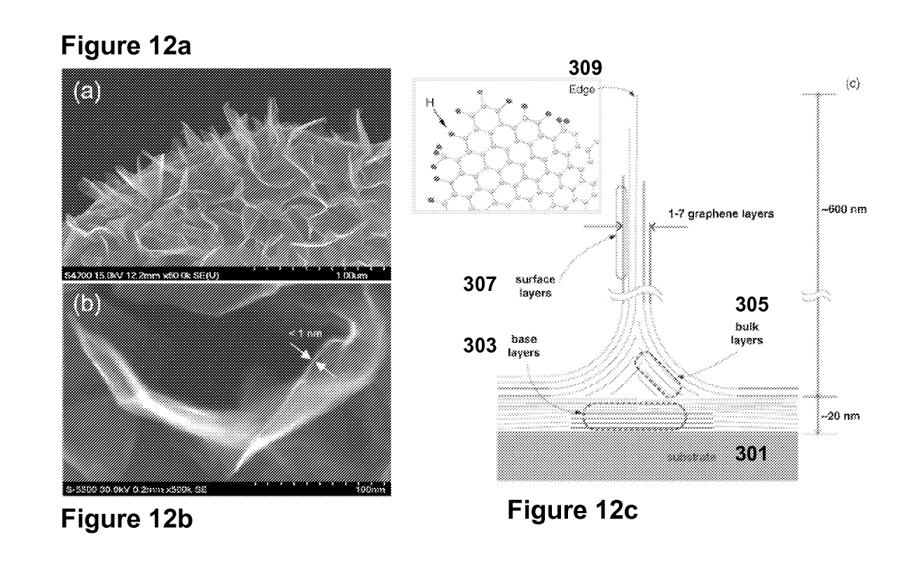

FIGS. 12a and 12b show scanning electron micrographs of the CNS structure. The edges are predominantly one to five atomic planes thick but may often be terminated in single or double graphene planes. The Hitachi S-4700 can detect the edges of approximately 1 nm which corresponds to four graphene sheets.

As shown in the schematic drawing of FIG. 12c, a significant quantity of hydrogen is incorporated on the surface and in between the sheets. The growth of CNS begins with a base layer (303) of graphite sheets parallel with the surface of the substrate (301) to about ˜20 nm thick (˜80 layers of AB stacking) and then, the growth turns vertically upward at grain boundary defects, forming structures comprising bulk layers (305), surface layers (307), and edges (309).

Without wishing to be bound by a particular theory, the probability of vertical growth is then greatly enhanced by the electric field and the higher probability of carbon atoms forming sp² bonds to the growing edge (309) compared to the much weaker tetragonalization bonding on the sheet surface. The energetic hydrogen neutrals and ions in the plasma impacting the growing walls sputter away most weakly bound nuclei or amorphous C. These energetic atoms and ions also are responsible for the defects observed. The inset of FIG. 12c represents the C—Hₓ terminations on zigzag or armchair edges, as well as dangling bonds or defect sites, with x=1-3 atoms of hydrogen. Density functional studies on the array of bonding sites on a perfect graphene surface and on an array of sites on the edges suggest that these adsorption energies can run from 0.5 to 3 eV. Temperature desorption spectroscopy studies have shown that the surface hydrogen and the bulk hydrogen are removed during ramping of the samples to 1000° C., but much of the edge-bound H probably remains intact.

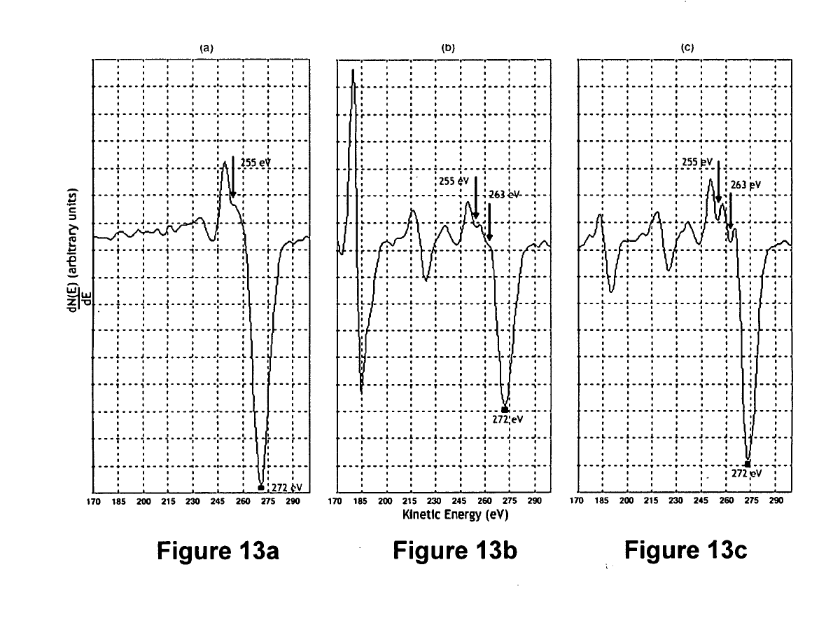

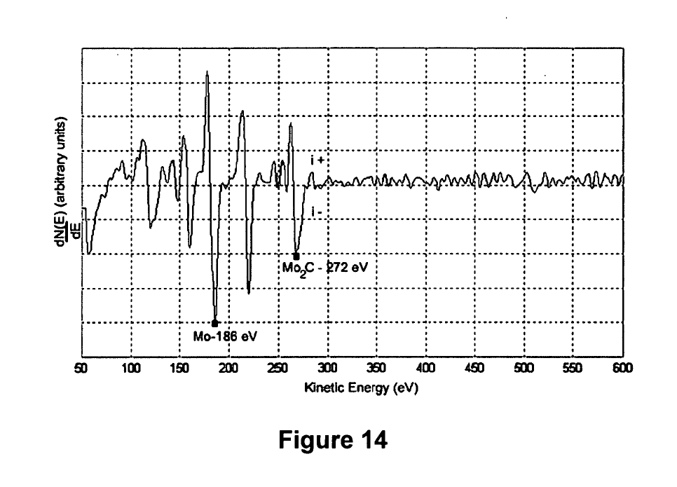

The AES spectra of the as-grown CNS after bakeout (275° C. for 2 h) is shown in FIG. 13a. Only a C KLL signal is detected with the exception of a small indication (<1%) of the oxygen KLL which is probably associated with an adsorbed C_{X}O_{Y}H_{Z} complex. FIG. 13b is the AES spectrum of this film with the PVD coating of Mo. An estimate of the thin film thickness based on the reduction in the C signal indicates approximately 3 monolayers of Mo coating the CNS surface. This is a very rough estimate because of disordered CNS topography. Standard thermo-chemical data suggest that formation of the Mo₂C requires an increase in temperature to ˜900° C. to achieve stoichiometric carbide. However, the “dolphin peak” for graphitic/amorphous C (between ˜245 and 290 eV) contains the beginning structure of carbide formation (maxima/minima between 263 and 272 eV). This overlayer AES structure has been observed at temperatures as low as the deposition temperature of ˜75° C. FIG. 13c is the AES spectrum after heating the sample in situ at ˜100° C. increments for 10 min to 1000° C. The characteristic carbide triple peak between 263 and 272 eV becomes far more pronounced and indicates that substantially more carbide was formed. The amount of carbide was determined by the method of Baldwin et al., (D. A. Baldwin, et al., Appl. Surf. Sci. 25, 364 (1986), herein after “Baldwin”), utilizing the asymmetry ratio, AR=i⁺/i⁻, where i⁺ and i⁻ are the positive and negative portions of the major peak in the carbide AES signal. FIG. 14 is the AES spectrum of a pure Mo₂C surface (99.98% Mo₂C powder from Alfa Aesar pressed uniformly into a pure polycrystalline Al substrate) after Ar ion sputtering for 10 min at 5 kV and 5 mA current. The major peak between 263 and 272 eV is distinct and serves as a calibration of the superimposed carbide signal of the coated CNS. From FIG. 13, we estimated the pure carbide asymmetry ratio, AR=i⁺/i⁻=0.7. The fraction of Mo₂C was calculated from the AES spectra at each 100° C. interval as I (Mo₂C)=r+i⁺/AR.

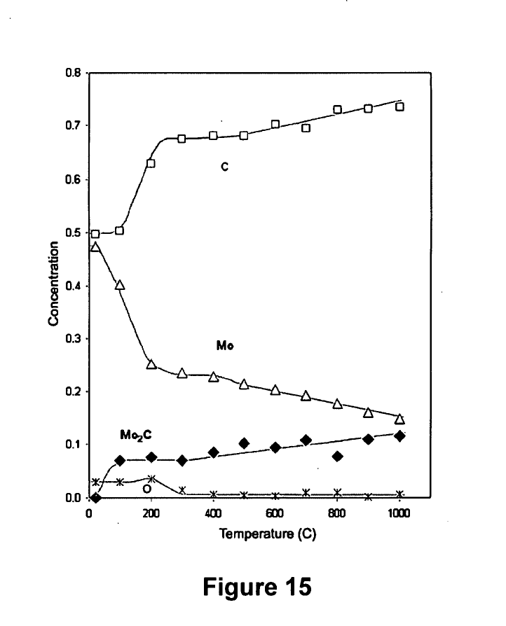

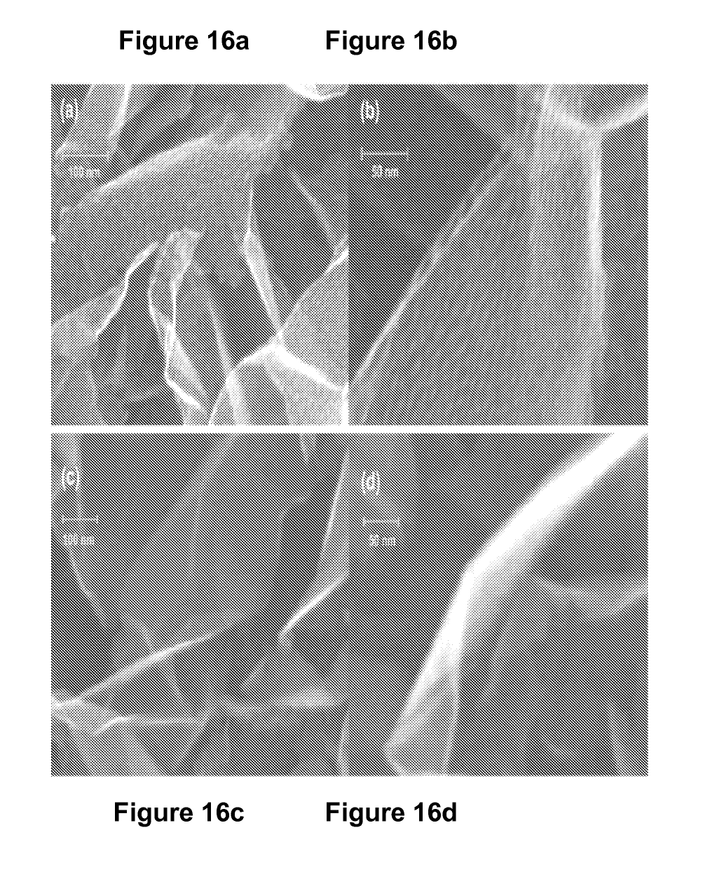

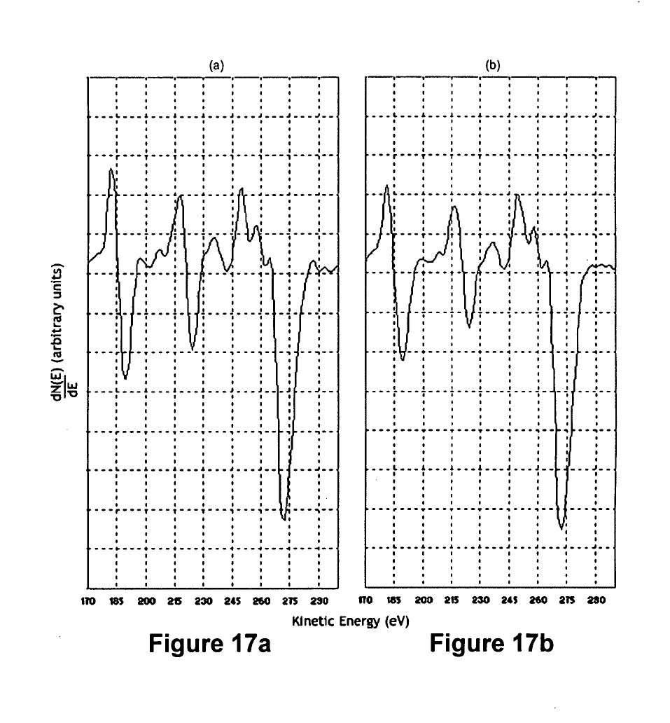

FIG. 15 is a plot of the variation in AES concentrations of the C KLL (272 eV), Mo₂C, Mo LMM (186 eV), and the 0 KLL (510 eV) as a function of temperature. The Mo peak drops rapidly in concert with the increasing Mo₂C and becomes steady at ˜200° C., suggesting that the reaction to form carbide is virtually complete. The rapid formation of the carbide is to be expected since there are only a few monolayers of Mo on a very rough graphite surface so the C has many avenues to diffuse toward Mo atoms. The carbide most likely formed from vicinal adventitious C on the surface and in defects. The C and Mo₂C peaks remain stable as the temperature is increased to about 400° C. where there is a slight increase as a function of temperature. Also, at this point, the Mo LMM peak begins to gradually decay. When the vicinal C is depleted, the unreacted Mo progressively diffuses into the bulk of the CNS via defects. FIGS. 16a and 16b are scanning electron micrographs of the coated CNS sample taken to 1000° C. The underlying graphite structure is quite stable at 1000° C. and does not react with the Mo coating. During the temperature increase to 1000° C., the Mo₂C has aggregated into the form of beads on the order of 10 nm diameter. FIGS. 16c and 16d show a CNS sample coated under identical conditions but only heated to 275° C. No beading is detected and the carbide coating appears uniform. A digital superposition of the pure graphite AES signal and the stoichiometric Mo₂C AES signal (shown in FIG. 14) was constructed to confirm the actual observed signal. The intensities were assigned by weighting the layers of carbide and by weighting the Auger electron contribution of the underlying C signal. The two spectra are shown in FIGS. 17a and 17b, respectively. In order to match the experimentally observed signal to the superposition, approximately two layers of Mo₂C had to be assumed instead of three. Without wishing to be bound by a particular theory, a likely reason for the difference is that the irregular geometry of the CNS gives an overestimate of the thickness by the standard uniform film techniques to account for the attenuation of the C peak and the inelastic mean free path of the KLL electrons through the Mo₂C overlayer.

The ultimate film composition that results from the physical vapor deposition of 3 mL of Mo on CNS with a thermal-vacuum treatment to 275° C. is very likely that of Mo₂C. Although, Lu et al. (J. Lu, et al., Thin Solid Films 370, 203 (2000), herein after “Lu”) have shown that the composition of molybdenum carbide is very complex and quite dependent on environmental factors. X-ray diffraction (XRD) data show that the Mo₂C film can be formed by annealing of δ-MoC_{0.67} in vacuum for 1 h at 1000° C. Lu also suggests that β-Mo₂C is more likely to form in an environment of low gaseous hydrogen where 1000° C. for 3 h gives β-Mo₂C. In this work, the AES spectra as a function of temperature clearly show that the well-known carbide “triple peak” at 272 eV begins to form immediately and is completed at 200° C. (see FIG. 15). The characteristic AES spectra are also consistent with XRD data as published in E. Silberberg, et al. (E. Silberberg, et al., Surf. Interface Anal. 27, 43 (1999), herein after “Silberberg”) and K. L. Moazed, et al. (K. L. Moazed, et al., J. Appl. Phys. 68, 2246 (1990), herein after “Moazed”), confirming carbide formation.

Without wishing to be bound by a particular theory, it is likely that the physically deposited Mo weakly interacts with the underlying surface and does not break the sp² bonding in the hexagonal graphitic array, but instead reacts with the nearby more weakly bound adventitious carbon located in amorphous islands or defects. At low temperatures, the Mo remains localized and alters the hydrogen termination, CHₓ, where x=1-3, and then thermally converts to Mo₂C, probably by C diffusion to the Mo. Mikhailov et al. (S. Mikhailov, et al., Solid State Commun. 93, 869 (1995), herein after “Mikhailov”) suggest that Mo replaces the hydrogen termination on chemical vapor deposition diamond coatings after a 400° C. anneal for 1 h, and that the C diffusion is very dependent on the quantity of other interstitials absorbed in the Mo film (concentration dependent). They found that the film became Ohmic and confirmed that it was stoichiometric Mo₂C. Leroy et al. (W. P. Leroy, et al., J. Appl. Phys. 99, 063704 (2006), herein after “Leroy”) have studied the formation of Mo₂C on carbon nanotubes (CNT) and have found that the formation of the carbide is independent of the chemical nature of the substrate but requires a formation temperature of 850° C. with and activation energy of 3.15 eV. Consistently with Leroy, in this example, the substrate resists carbide formation. The beading that occurs with the elevated temperature is further evidence that the substrate does not take part in the reaction with the Mo film (see FIG. 16). The difference in temperature at which the carbide is formed, i.e., 200° C. in this work compared to the 850° C. observed by Leroy, is most likely a function of the layer thickness, i.e., ˜1 nm on a very disordered surface compared to the 30 nm described by Leroy, and the fact that the Mo was deposited in this work by physical vapor deposition at several orders of magnitude lower background pressure (1×10⁻⁸ Torr). Further, film of this example was heated in UHV rather than the He atmosphere described by Leroy, which most likely lead to a relatively higher impurity contamination in the resulting film.

### Example 8

### Field Emission Properties of Mo_{X}C—CNS

Field emission experiments are conducted in a dedicated UHV system, utilizing a diode design fabricated on the end of a 1.9 cm diameter Cu cylindrical rod electrical-vacuum feedthrough. As shown in FIG. 11, the diode cartridge assembly is loaded with a CNS dot sample (203) of 3 mm diameter on a doped silicon substrate (201). A spring-loaded cathode (209) rests on two alumina spacers (207) defining the diode gap of ˜250 μm. The design permits active cooling of the anode (211) and the cathode (209) during high current runs in order to minimize Paschen-breakdown arcs that can occur from hydrogen desorption. Although CNSs are very high purity carbon, hydrogen incorporation in the bulk is quite significant. Previous temperature desorption spectroscopy measurements have shown that there is one H atom for every five atoms in the bulk, when CNSs are grown in a hydrogen and methane plasma. During field emission, the sheets can become quite hot and subsequently desorb hydrogen within the parallel plate geometry of the diode. Since the distance between the cathode and the anode is on the order of 250 μm, conductance is limited and pressure between the plates can increase dramatically during this desorption. Therefore, a voltage of 1-5 kV can precipitate an arc that results in catastrophic failure. This requires either vacuum firing to remove the bulk of the hydrogen and/or extensive conditioning at lower currents where the controlled temperature increase allows modest thermal desorption.

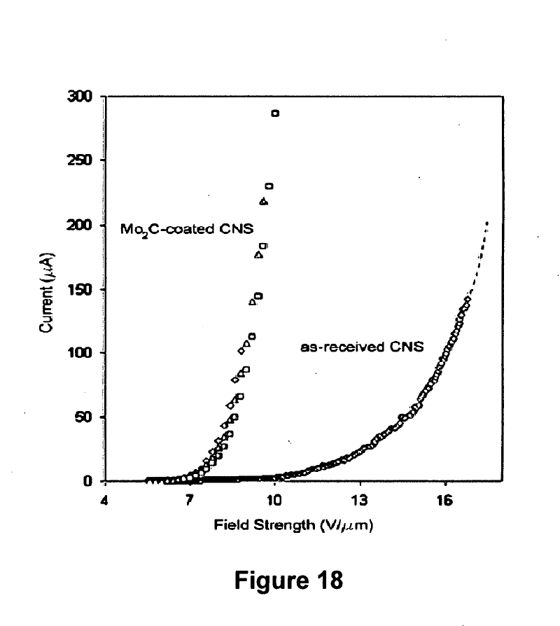

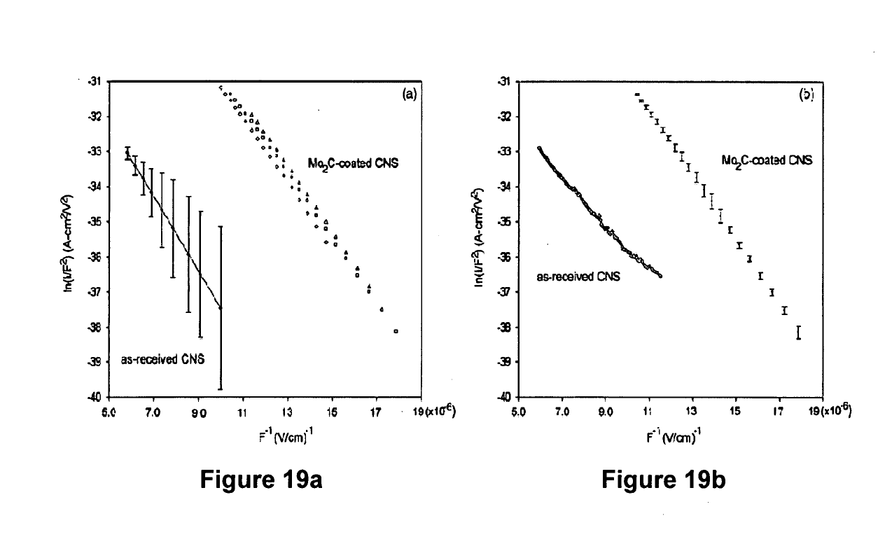

The Mo₂C/CNS sample is placed in the aforementioned diode cartridge and then installed in the UHV system for field emission measurements. FIG. 18 shows I-V characteristics of the as-grown CNS compared to the carbide-coated sample. A representative CNS sample is plotted that shows a turn-on of I=10 μA at an electric field of approximately 10 V/μm. The CNS current exponentially increased, consistent with Fowler-Nordheim theory as published in Fowler and Nordheim (R. H. Fowler, and L. Nordheim, Proc. R. Soc. London, Ser. A 199, 173 (1928), herein after “Fowler-Nordheim”). The field was increased to about 17 V/μm which gave a current of 120 μA. Current densities with as-grown CNS have been achieved that are greater than 200 mA/cm². High current behavior generates heat and can result in significant morphological changes that alter the emission sites and, therefore, the current may vary. FIG. 18 shows a low turn-on, 6 V/μm, of Mo₂C—CNS and a sharp exponential rise, both of which are consistent with the expected lower work function. Thus, a given value of electric field will result in an emission current from the carbide-coated sample in excess of two orders of magnitude greater than what is measured for the as-grown CNS, consistently with Fowler-Nordheim theory. FIG. 19a presents Fowler-Nordheim plots of the carbide-coated CNS data for three separate maximum currents from 100 to 300 μA compared to the standard deviations from an average least mean squares fit of six as-grown CNS samples. The spread in the CNS data highlights the unstable Fowler-Nordheim behavior observed in CNS. FIG. 19b shows the Fowler-Nordheim plot of representative as-grown CNS raw data illustrating a slight characteristic deviation from linearity that has been observed in virtually all research with nanocarbon morphologies. Also shown in FIG. 19b is the Fowler-Nordheim plot of average raw data from a Mo₂C/CNS sample with a maximum current of 200 μA; the standard deviations over 100 ramps are included. The coated samples show an extraordinary linearity over two and a half orders of magnitude in current seldom seen in any Fowler-Nordheim (F—N) plot of carbon nanomaterials. From the linear least mean squares fit, the correlation coefficients (i.e., R²=0.999) are indicative of almost perfect F—N behavior and, therefore, are representative of ideal metallic/free electron theory behavior. Furthermore, excellent repeatability and stability in the coated samples are observed compared to that of the as-grown CNS. The data at 400 μA (not shown) are somewhat altered compared to the lower currents probably because of changes in the emission edges due to current effects. As long as the current level was maintained at a maximum of 300 μA or less, the data were repeatable over hundreds of runs. Table III shows the slope, intercept, and correlation coefficient data in tabular form for the carbide-coated and as-grown samples.

TABLE III
The slope, intercept, and correlation
coefficient of a linear fit of each F-N plot at a given
maximum current. The 400 μA data maintain linearity,
but the slope and intercept begin to alter with changes
in the emission edges due to higher current density.

| | Max. | | | |
|---|---|---|---|---|
| | Current | | Vertical | Correlation |
| | (μA) | Slope | intercept | coefficient |
| Mo₂C | 100 | −921 968 | −21.439 | 0.9999 |
| | 200 | −911 864 | −21.796 | 0.9997 |
| | 300 | −924 349 | −21.906 | 0.9996 |
| | 400 | −945 707 | −22.241 | 0.9996 |

Without wishing to be bound by a particular theory, the I-V data presented above suggest that many of the CNS emission sites terminated with H have been replaced by Mo and the resulting surface electric field altered to increase the emission current. The lower surface mobility at such low temperatures has likely caused Mo atoms to remain localized close to their initial impact sites; the amorphous C has diffused to and reacted with this Mo. Hence, the resulting carbide is likely to be at the active emission sites. The atomic configuration of the resulting structure may be such that the dipole moment substantially increased the accelerating field and lowered the effective work function yielding the observed current increase (>10²) and the observed carbide-coated CNS turn on at <6 V/μm.

Without wishing to be bound by a particular theory, it is believed that the reason for degradation at ≧400 μA may be the result of heating, electrotransport, or possibly, electron stimulated alteration of the terminal bonding. The linearity observed in these F—N plots also suggests a Mo₂C metal-like termination compared to a hydrogen covalent termination. In most of all CNT and CNS F—N plots, there is a nonlinearity, i.e., a slight “s” shape of the curve and often scatter in the data. Some exceptions to this exist but very few. It is also probable that the lower the work function at the active emission sites, the more likely emission occurs in concert as from a single source. Gröning et al. (O. Gröning, et al., J. Vac. Sci. Technol. B 18, 665 (2000), herein after “Groning”) reported excellent field emission and F—N linearity from a mixture of Ni/Fe capped and open CNT but gave no acceptable and firm justification as to whether the open-ended tubes or the capped end was emitting. Those authors suggest that the emission may be from open ended versions based on the ring-like emission pattern but the conclusion is uncertain. A metallic termination or cap would be more consistent with the data reported here.

The good linearity of the data provides some confidence in the parameters that comprise the F—N equation (1), where a=1.54×10⁻⁶ A eV V⁻², b=6.83×10⁷ eV^{-3/2}V cm⁻¹, F_{micro}=βF_{macro}, J is the current density, I is the measured current, F the field strength, and φ is the work function:

$$J = \frac{I}{α} = \frac{a {F}^{2}}{φ} exp [ \frac{- b {φ}^{3 / 2}}{F} ] A {cm}^{- 2} , \qquad ( 1 )$$

Without wishing to be bound by a particular theory, if it is considered that the observed edge width is ˜1 nm and the average length of the emission sites estimated by taking contours of approximately constant height in the SEM images (FIG. 15) is ˜50 nm, we calculate an average emitter-site area of ˜50 nm² or 5×10⁻¹³ cm². From the F—N equation, the phenomenological or equivalent emission site area is given by Eq. (2), where R is the vertical intercept of the F—N plot, S is the slope, and we assume 0 to be 3.7 eV for Mo₂C.

$$α ( {cm}^{2} ) = \frac{exp ( R ) {S}^{2}}{{ab}^{2} {φ}^{2}} ≅ 3 \times {10}^{- 9} {cm}^{2} , \qquad ( 2 )$$

Therefore, without wishing to be bound by a particular theory, it can be roughly estimated that there are approximately 5000 emission sites in the 7 mm² area. The current that each emitter will carry at a total current of 500 μA (threshold for edge degradation) then is 0.1 μA. This appears to be a reasonable estimate. In the SEM of the CNS, we observe some variation in height of the emission edges, and many edges that are not as high as others will not contribute to the emission because of electric field shielding. The highest and thinnest edges will have the highest β factor and will turn on first. If the field is increased beyond this level, some of these emitters will tend to burn out and a higher field will be required to turn on lower β factor emission sites. Carbide-coated sheets did not behave in this way in that they needed minimal conditioning. It is likely that not only a minimal conditioning is required but also that the stability of sites is improved so that at current levels of <400 μA, these emission sites are quite stable and are the only ones that significantly contribute to the emission. In other words, other emitters may turn on at higher electric fields but do not significantly contribute to the total current. Using the reported work function for Mo₂C of 3.7 eV, an average field enhancement factor was found to be β=530 for the Mo₂C/CNS:

$$β = \frac{- b {φ}^{3 / 2}}{S} ≅ 530.$$

An estimate of β for curved tips can be used to approximate the change in the field enhancement factor with a 2 mL coating of Mo₂C (c_{lattice}=0.473 nm) over a 1 nm diameter tip, where r is the radius and k is a constant of ˜5:

If the coated CNS is assumed to be β=530, then the bare CNS by Eq. (4) has a field enhancement factor of approximately β=1039. Without wishing to be bound by a particular theory, if we assume that the past measurements of the work function of Mo₂C are reasonably accurate (−3.7 eV), one can calculate the work function of the as-grown CNS by comparing the slopes and the change in the field enhancement factor with addition of a thin film coating. From Eq. (5):

$${φ}_{CNS} = {( \frac{{β}_{CNS} {S}_{CNS}}{{β}_{{Mo}_{2} C} {S}_{{Mo}_{2} C}} )}^{2 / 3} {φ}_{{Mo}_{2} C} , \qquad ( 5 )$$

we find that for a slope S_{CNS}=1×10⁶, φ=4.7 eV which is in good agreement with that measured for graphite and CNT. It is likely that the graphite work function measurements are dominated by defects and field induced micro- and nano-tips that are terminated with hydrogen, so similar values to that of the CNT are reasonable. Gröning reports that the work function of the multiwall CNT measured by field emission energy distribution is 5.13 eV and compares that to ordinary graphite.

### INCORPORATION BY REFERENCE

All publications, patents, and patent applications cited herein are hereby expressly incorporated by reference in their entireties and for all purposes to the same extent as if each was so individually denoted.

### EQUIVALENTS

While specific embodiments of the subject invention have been discussed, the above specification is illustrative and not restrictive. Many variations of the invention will become apparent to those skilled in the art upon review of this specification. The full scope of the invention should be determined by reference to the claims, along with their full scope of equivalents, and the specification, along with such variations.

The articles “a” and “an” are used herein to refer to one or to more than one (i.e. to at least one) of the grammatical object of the article. By way of example, “a nanoflake” means one nanoflake or more than one nanoflake.

Any ranges cited herein are inclusive.

We claim:

1. A composition comprising thin-film-coated carbon nanoflakes, wherein a thin film portion of the thin-film-coated carbon nanoflakes comprises chromium oxide having an atomic composition percentage of chromium between 0.33 and 0.40 or comprises molybdenum carbide.

2. The composition of claim 1, wherein the thickness of the carbon nanoflake portion of said thin-film-coated carbon nanoflakes is less than 3 nm.

3. The composition of claim 1, wherein:
the thin-film portion comprises chromium oxide, and
the thickness of the thin-film portion is between about 0.5 nm and about 15 nm.

4. The composition of claim 1, wherein:
the thin-film portion comprises molybdenum carbide, and
the thickness of the thin-film portion is between about 0.5 nm and about 15 nm.

5. The composition of claim 1, wherein the atomic composition percentage of chromium in the chromium oxide coating on said chromium oxide-coated carbon nanoflakes is between 0.36 and 0.38.

6. The composition of claim 1, wherein the turn-on field of said thin-film-coated-carbon nanoflakes is less than 3.5 V/μm.

7. A field emitter comprising the thin-film-coated carbon nanoflakes of claim 1.

8. A composition comprising carbon nanoflakes coated with a low Z compound, wherein an effective electron emission of the carbon nanoflakes coated with the low Z compound is improved compared to an effective electron emission of the same carbon nanoflakes that are not coated with the low Z compound or of the low Z compound that is not coated onto the carbon nanoflakes.

9. The composition of claim 8, wherein the low Z compound is selected from a metal oxide, nitride, carbide, boride, or a combination thereof.

10. The composition of claim 9, wherein the metal comprises a transition metal, a rare earth group metal, an alkali group metal or an alkaline earth group metal.

11. The composition of claim 9, wherein the low Z compound is selected from lanthanum boride, scandium boride, yttrium boride, molybdenum carbide, titanium oxide, chromium oxide, hafnium oxide, thorium oxide, molybdenum oxide, zirconium oxide, or cerium oxide.

12. The composition of claim 9, wherein the low Z compound comprises a binary or a ternary compound.

13. The composition of claim 9, wherein the low Z compound coating has a thickness of 0.5 to 5 nm.

14. The composition of claim 8, wherein a thickness of the carbon nanoflake portion of said coated carbon nanoflakes is less than 3 nm.

15. The composition of claim 14, wherein the carbon nanoflakes comprise carbon nanosheets.

16. The composition of claim 8, wherein:
the effective electron emission is selected from at least one of work function, turn-on voltage and field enhancement factor; and
the carbon nanoflakes coated with the low Z compound have at least one of a lower work function, a lower turn-on voltage and a higher field enhancement factor compared to that of the same carbon nanoflakes that are not coated with the low Z compound or of the low Z compound that is not coated onto the carbon nanoflakes.

17. A field emitter comprising the coated carbon nanoflakes of claim 8.

18. A method of making coated carbon nanoflakes, comprising:
forming a metal coating on the carbon nanoflakes; and
converting the metal coating to coating comprising at least one of a metal oxide, nitride, carbide, boride, or a combination thereof, such that an effective electron emission of the coated carbon nanoflakes is improved compared to an effective electron emission of the carbon nanoflakes that are uncoated or of the coating that is not coated onto the carbon nanoflakes.

19. The method of claim 18, wherein the step of converting comprises at least one of exposing the metal coating to an atmosphere comprising oxygen, nitrogen, carbon, boron or a combination thereof or reacting the metal coating with the carbon nanoflakes.

20. The method of claim 18, wherein:
the coating is selected from lanthanum boride, scandium boride, yttrium boride, molybdenum carbide, titanium oxide, chromium oxide, hafnium oxide, thorium oxide, molybdenum oxide, zirconium oxide, cerium oxide or a ternary compound thereof;
the coating has a thickness of 0.5 to 5 nm; and
the thickness of the carbon nanoflake portion of said coated carbon nanoflakes is less than 3 nm.

21. The method of claim 18, wherein:
the metal is molybdenum; and
the step of converting the metal coating to a metal carbide coating is conducted under a temperature of 100° C. to 800° C.
